(19) United States
(12) Patent Application Publication
(10) Pub. No.: US 2005/0188312 A1
(43) Pub. Date: Aug. 25, 2005

(54) Wireless communications device user interface

(75) Inventors: Andrew Bocking, Waterloo (CA); Raymond Vander Veen, Waterloo (CA); Lianghua Yang, Waterloo (CA)

Correspondence Address: OGILVY RENAULT LLP, 1981 MCGILL COLLEGE AVENUE, SUITE 1600, MONTREAL, QC, H3A2Y3, CA

(73) Assignee: Research in Motion Limited, Waterloo (CA)

(21) Appl. No.: 10/782,964

(22) Filed: Feb. 23, 2004

(51) Int. Cl. G06F 3/00

(52) U.S. Cl. 715/739; 715/752; 715/758; 715/810

(57) ABSTRACT

A user interface for wireless communications device includes a component to compose a destination for an outgoing communication generated by the device. The component provides alternative composition means comprising a prompt for receiving the destination from a user and a list of candidate destinations from which the user may select the destination. The component may be invoked directly from a home screen of the user interface by keying the destination. Entry from the main screen may populate the prompt with the keyed destination to speed calling operations.

### FIELD OF THE INVENTION

The present invention relates generally to a wireless communications device and, more particularly, to a user interface and method for controlling such a device and a device configured to operate according to the method.

### DESCRIPTION OF THE RELATED ART

With the proliferation of communications services available on wireless communications devices, it becomes increasingly complex to create a single device that can excel at many different functions. Many critics claim that a wireless telephone device can never make a good handheld personal digital assistant (PDA) device and a handheld PDA device will never make a good wireless telephone. However, many users of wireless devices desire to have multiple services and functionality on a single device.

Representing multiple services and functions to a user on a single wireless device presents a number of challenges to the designer of a user interface, particularly a graphical user interface (GUI), for controlling the device.

Typically, GUIs for wireless mobile devices comprise a main or home screen and one or more sub-screens that may be navigated from the main screen. Notification icons are often rendered on a portion of the main screen to indicate a new event such as the receipt of a new message, for example, electronic mail (e-mail) or other service event such as a calendar reminder or alarm and other status information such as time, date and battery life. For each type of service or function available via the device, a graphical image or icon is often rendered on a major portion of the main screen, which icon may be selected using a cursor or other means to launch a specific GUI for the selected service or function. However, such interfaces give relatively equal priority to each of those services or functions, requiring the user to select an icon or activate another short-cut mechanism (e.g. a specific key such as “m” for e-mail messages, “p” for phone, etc.) to launch the service or function.

However, certain users of multi-tasking wireless communications devices use such devices primarily for one of their communications abilities, for example, as a telephone. Often these and other users desire easier access to the features associated with the primary communications ability such as out call dialing or other communication initiation.

Accordingly, there is a resulting need for a method and apparatus that addresses one or more of these shortcomings.

### SUMMARY OF THE INVENTION

The present invention relates to a wireless communications device user interface and method for controlling the device. The invention also relates to a device configured to operate according to the method and to computer software medium embodying code for carrying out the method.

In accordance with an aspect of the invention there is provided a wireless communications device for use in a wireless network comprising: a user interface for controlling the wireless communications device including a component to compose a destination for an outgoing communication generated by the wireless communications device, the component providing alternative composition means comprising a prompt for receiving the destination from a user; and a hot list of candidate destinations from which the user may select the destination.

The wireless communications device may include a key-based input device to input the destination to the prompt. In accordance with a feature of this aspect, the user interface comprises a home screen component from which to invoke a feature from among a plurality of features provided by the device and the component to compose a destination is invokable from the home screen component automatically in response to an input of a portion of the destination from the key-based input device. Typically, for voice-based communications in a telephony application, the destination is a telephone number to be called and the input is a portion of a telephone number. Preferably, the portion of the destination populates the prompt when the component to compose a destination is invoked.

In accordance with a feature of the present aspect, the wireless communications device includes at least one auxiliary input device and the component to compose a destination is invokable in response to at least one of: an interaction with a home screen component of the user interface; and one of the auxiliary input devices dedicated to invoke the component to compose a destination.

When invoked, the component to compose a destination is navigable by a user to move between the prompt and hot list. Advantageously, navigation provides a choice to the user, allowing the keying of a destination known to the user or the selection of a destination from among candidate destinations stored by the device. Preferably, in the wireless communications device, the component to compose a destination is adapted to provide a filtered list of destinations from a store of destinations on the device in response to a filter input by the user. The filtered list of destinations is selectable by the user to choose a destination for an outgoing communication. The filtered list may be constructed from a list of contacts list stored to the device or otherwise coupled thereto.

In accordance with a further aspect of the invention, there is provided for a wireless communications device for use in a wireless network, a method for composing a destination for an outgoing communication generated by the device. The method comprises providing a composition screen including, together, a prompt for inputting the destination by a user; and a hot list for selecting the destination from a list of candidate destinations by the user.

Additional aspects and features of the invention will be apparent to those skilled in the art and include a computer program product having a computer readable medium tangibly embodying computer executable code for composing a destination for an outgoing communication generated by a wireless communications device for use in a wireless network.

### BRIEF DESCRIPTION OF THE DRAWINGS

Embodiments of present invention will now be described by way of example with reference to attached figures, wherein:

FIG. 1 is a block diagram which illustrates pertinent components of a wireless communications device which communicates within a wireless communication network in accordance with the prior art;

FIG. 2 is a more detailed diagram of a preferred wireless communications device of FIG. 1 in accordance with the prior art;

FIG. 3 is an illustration of an exemplary main screen for a wireless communications device such as the devices of FIGS. 1 and 2;

FIGS. 4 and 5 are illustrations of user interface screens for a telephone application for the device of FIG. 3, in accordance with an embodiment of the invention;

FIGS. 6 through 8 are illustrations of an embodiment in which a cursor navigates the character field in a phone dialog box for editing the destination, inserting and/or deleting characters;

FIGS. 9 and 10 are illustrations of embodiments of a prompt indicator field for entering a telephone number via a keypad or pasting operation;

FIG. 11 is an illustration of an embodiment of a screen in which call and cancel icon buttons have been added;

FIGS. 12 and 13 are flowcharts which describe a method for a telephone application user interface in accordance with an embodiment of the invention.

### DETAILED DESCRIPTION

A user interface for wireless communications device includes a component to compose a destination for an outgoing communication generated by the device. The component provides alternative composition means comprising a prompt for receiving the destination from a user; and a hot list of candidate destinations from which the user may select the destination. The component may be invoked directly from a home screen of the user interface by keying the destination. Entry from the main screen may populate the prompt with the keyed destination to speed calling operations.

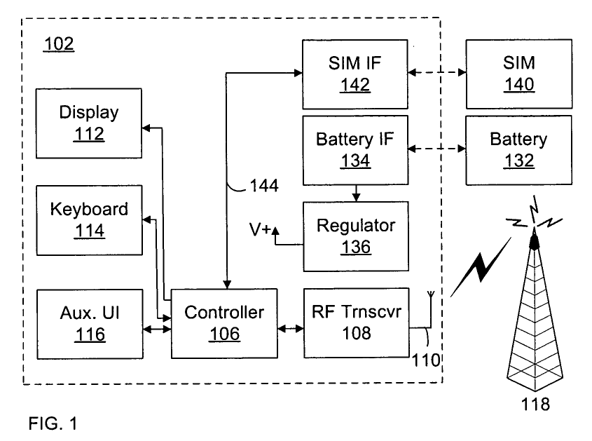

FIG. 1 is a block diagram of a communication system 100 which includes a mobile station 102 which communicates through a wireless communication network symbolized by station 104. Mobile station 102 preferably includes a visual display 112, a keyboard 114, and perhaps one or more auxiliary user interfaces (UI) 116, each of which is coupled to a controller 106. Controller 106 is also coupled to radio frequency (RF) transceiver circuitry 108 and an antenna 110.

Typically, controller 106 is embodied as a central processing unit (CPU) which runs operating system software in a memory component (not shown). Controller 106 will normally control overall operation of mobile station 102, whereas signal-processing operations associated with communication functions are typically performed in RF transceiver circuitry 108. Controller 106 interfaces with device display 112 to display received information, stored information, user inputs, and the like. Keyboard 114, which may be a telephone type keypad or full alphanumeric keyboard, is normally provided for entering data for storage in mobile station 102, information for transmission to network 104, a telephone number to place a telephone call, commands to be executed on mobile station 102, and possibly other or different user inputs.

Mobile station 102 sends communication signals to and receives communication signals from the wireless network 104 over a wireless link via antenna 110. RF transceiver circuitry 108 performs functions similar to those of a base station and a base station controller (BSC) (not shown), including for example modulation/demodulation and possibly encoding/decoding and encryption/decryption. It is also contemplated that RF transceiver circuitry 108 may perform certain functions in addition to those performed by a BSC. It will be apparent to those skilled in art that RF transceiver circuitry 108 will be adapted to particular wireless network or networks in which mobile station 102 is intended to operate.

Mobile station 102 includes a battery interface (IF) 134 for receiving one or more rechargeable batteries 132. Battery 132 provides electrical power to electrical circuitry in mobile station 102, and battery IF 132 provides for a mechanical and electrical connection for battery 132. Battery IF 132 is coupled to a regulator 136 which regulates power to the device. When mobile station 102 is fully operational, an RF transmitter of RF transceiver circuitry 108 is typically keyed or turned on only when it is sending to network, and is otherwise turned off to conserve resources. Similarly, an RF receiver of RF transceiver circuitry 108 is typically periodically turned off to conserve power until it is needed to receive signals or information (if at all) during designated time periods.

Mobile station 102 operates using a Subscriber Identity Module (SIM) 140 which is connected to or inserted in mobile station 102 at a SIM interface (IF) 142. SIM 140 is one type of a conventional “smart card” used to identify an end user (or subscriber) of mobile station 102 and to personalize the device, among other things. Without SIM 140, the mobile station terminal is not fully operational for communication through the wireless network. By inserting SIM 140 into mobile station 102, an end user can have access to any and all of his/her subscribed services. SIM 140 generally includes a processor and memory for storing information. Since SIM 140 is coupled to SIM IF 142, it is coupled to controller 106 through communication lines 144. In order to identify the subscriber, SIM 140 contains some user parameters such as an International Mobile Subscriber Identity (IMSI). An advantage of using SIM 140 is that end users are not necessarily bound by any single physical mobile station. SIM 140 may store additional user information for the mobile station as well, including datebook (or calendar) information and recent call information.

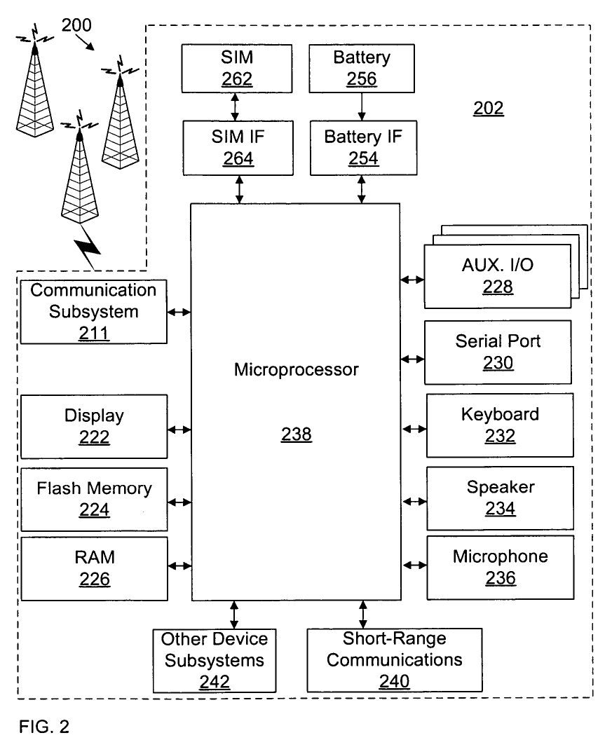

Mobile station 102 may consist of a single unit, such as a data communication device, a multiple-function communication device with data and voice communication capabilities, a personal digital assistant (PDA) enabled for wireless communication, or a computer incorporating an internal modem. Alternatively, mobile station 102 may be a multiple-module unit comprising a plurality of separate components, including but in no way limited to a computer or other device connected to a wireless modem. In particular, for example, in the mobile station block diagram of FIG. 1, RF transceiver circuitry 108 and antenna 110 may be implemented as a radio modem unit that may be inserted into a port on a laptop computer. In this case, the laptop computer would include display 112, keyboard 114, one or more auxiliary UIs 116, and controller 106 embodied as the computer's CPU. It is also contemplated that a computer or other equipment not normally capable of wireless communication may be adapted to connect to and effectively assume control of RF transceiver circuitry 108 and antenna 110 of a single-unit device such as one of those described above. Such a mobile station 102 may have a more particular implementation as described later in relation to mobile station 202 of FIG. 2.

FIG. 2 is a detailed block diagram of a preferred mobile station 202. Mobile station 202 is preferably a two-way communication device having at least voice and advanced data communication capabilities, including the capability to communicate with other computer systems. Depending on the functionality provided by mobile station 202, it may be referred to as a data messaging device, a two-way pager, a cellular telephone with data messaging capabilities, a wireless Internet appliance, or a data communication device (with or without telephony capabilities). Mobile station 202 may communicate with any one of a plurality of fixed transceiver stations 200 within its geographic coverage area.

Mobile station 202 will normally incorporate a communication subsystem 211, which includes a receiver, a transmitter, and associated components, such as one or more (preferably embedded or internal) antenna elements and, local oscillators (LOs), and a processing module such as a digital signal processor (DSP) (all not shown). Communication subsystem 211 is analogous to RF transceiver circuitry 108 and antenna 110 shown in FIG. 1. As will be apparent to those skilled in field of communications, particular design of communication subsystem 211 depends on the communication network in which mobile station 202 is intended to operate.

Network access is associated with a subscriber or user of mobile station 202 and therefore mobile station 202 requires a Subscriber Identity Module or “SIM” card 262 to be inserted in a SIM IF 264 in order to operate in the network. SIM 262 includes those features described in relation to FIG. 1. Mobile station 202 is a battery-powered device so it also includes a battery IF 254 for receiving one or more rechargeable batteries 256. Such a battery 256 provides electrical power to most if not all electrical circuitry in mobile station 202, and battery IF 254 provides for a mechanical and electrical connection for it. The battery IF 254 is coupled to a regulator (not shown) which provides power V+ to all of the circuitry.

Mobile station 202 includes a microprocessor 238 (which is one implementation of controller 106 of FIG. 1) which controls overall operation of mobile station 202. Communication functions, including at least data and voice communications, are performed through communication subsystem 211. Microprocessor 238 also interacts with additional device subsystems such as a display 222, a flash memory 224, a random access memory (RAM) 226, auxiliary input/output (I/O) subsystems 228, a serial port 230, a keyboard 232, a speaker 234, a microphone 236, a short-range communications subsystem 240, and any other device subsystems generally designated at 242. Some of the subsystems shown in FIG. 2 perform communication-related functions, whereas other subsystems may provide “resident” or on-device functions. Notably, some subsystems, such as keyboard 232 and display 222, for example, may be used for both communication-related functions, such as entering a text message for transmission over a communication network, and device-resident functions such as a calculator or task list. Operating system software used by microprocessor 238 is preferably stored in a persistent store such as flash memory 224, which may alternatively be a read-only memory (ROM) or similar storage element (not shown). Those skilled in the art will appreciate that the operating system, specific device applications, or parts thereof, may be temporarily loaded into a volatile store such as RAM 226.

Microprocessor 238, in addition to its operating system functions, preferably enables execution of software applications on mobile station 202. A predetermined set of applications which control basic device operations, including at least data and voice communication applications, will normally be installed on mobile station 202 during its manufacture. A preferred application that may be loaded onto mobile station 202 may be a personal information manager (PIM) application having the ability to organize and manage data items relating to the user such as, but not limited to, instant messaging (IM), e-mail, calendar events, voice mails, appointments, and task items. Naturally, one or more memory stores are available on mobile station 202 and SIM 256 to facilitate storage of PIM data items and other information.

The PIM application preferably has the ability to send and receive data items via the wireless network. In a preferred embodiment, PIM data items are seamlessly integrated, synchronized, and updated via the wireless network, with the mobile station user's corresponding data items stored and/or associated with a host computer system thereby creating a mirrored host computer on mobile station 202 with respect to such items. This is especially advantageous where the host computer system is the mobile station user's office computer system. Additional applications may also be loaded onto mobile station 202 through network 200, an auxiliary I/O subsystem 228, serial port 230, short-range communications subsystem 240, or any other suitable subsystem 242, and installed by a user in RAM 226 or preferably a non-volatile store (not shown) for execution by microprocessor 238. Such flexibility in application installation increases the functionality of mobile station 202 and may provide enhanced on-device functions, communication-related functions, or both. For example, secure communication applications may enable electronic commerce functions and other such financial transactions to be performed using mobile station 202.

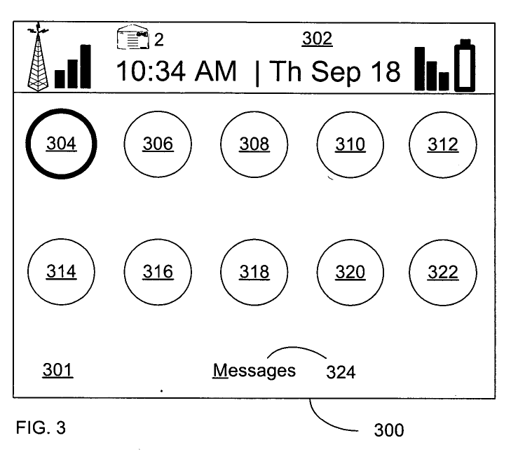

In a data communication mode, a received signal such as a text message, an e-mail message, or web page download will be processed by communication subsystem 211 and input to microprocessor 238. Microprocessor 238 will preferably further process the signal for output to display 222, to auxiliary I/O device 228 or both as described further herein below with reference to FIGS. 3-7. A user of mobile station 202 may also compose data items, such as e-mail messages, for example, using keyboard 232 in conjunction with display 222 and possibly auxiliary I/O device 228. Keyboard 232 is preferably a complete alphanumeric keyboard and/or telephone-type keypad. These composed items may be transmitted over a communication network through communication subsystem 211.

For voice communications, the overall operation of mobile station 202 is substantially similar, except that the received signals would be output to speaker 234 and signals for transmission would be generated by microphone 236. Alternative voice or audio I/O subsystems, such as a voice message recording subsystem, may also be implemented on mobile station 202. Although voice or audio signal output is preferably accomplished primarily through speaker 234, display 222 may also be used to provide an indication of the identity of a calling party, duration of a voice call, or other voice call related information, as some examples.

Serial port 230 in FIG. 2 is normally implemented in a personal digital assistant (PDA)-type communication device for which synchronization with a user's desktop computer is a desirable, albeit optional, component. Serial port 230 enables a user to set preferences through an external device or software application and extends the capabilities of mobile station 202 by providing for information or software downloads to mobile station 202 other than through a wireless communication network. The alternate download path may, for example, be used to load an encryption key onto mobile station 202 through a direct and thus reliable and trusted connection to thereby provide secure device communication.

Short-range communications subsystem 240 of FIG. 2 is an additional optional component which provides for communication between mobile station 202 and different systems or devices, which need not necessarily be similar devices. For example, subsystem 240 may include an infrared device and associated circuits and components, or a Bluetooth™ communication module to provide for communication with similarly-enabled systems and devices. Bluetooth™ is a registered trademark of Bluetooth SIG, Inc.

In accordance with an embodiment of the invention, mobile station 202 is a multi-tasking wireless communications device configured for sending and receiving data items and for making and receiving voice calls. To provide a user-friendly environment to control the operation of mobile station 202, an operating system resident on station 202 (not shown) provides a GUI having a main screen and a plurality of sub-screens navigable from the main screen.

Referring now to FIG. 3, there is an illustration of an exemplary main or home screen 300, in accordance with an embodiment of the invention, for display 222 of mobile station 202 providing a graphical user interface for controlling mobile station 202. Main screen 300 is divided into two main portions, namely an application portion 301 and a mobile station status portion 302. Mobile station status portion 302 provides an area for displaying status information such as time, date, battery and signal strength, etc. Application portion 301 provides an area for displaying and interacting with icons (e.g. 304-322), dialog boxes (not shown) lists or other menus (not shown) or other visual elements for various software applications and functions enabled by mobile station 202.

Associated with each icon 304-322 is a name (e.g. Messages) for the application which name is presented in a name region 324. The application name may indicate a shortcut key to activate the associated application. For example, the letter “M” of messages is highlighted by underlining or other means to indicate that keying this letter on keyboard 232 activates the messages application associated with icon 304.

Main screen 300 may not represent all application icons at once in application portion 301 within the confines of display 222. A user may be required to navigate or scroll through the icons of application portion 301 to view additional application icons. For simplicity, each icon is represented as a circle but persons of ordinary skill in the art will appreciate that other preferably representative graphics may be used.

In the exemplary main screen and GUI of mobile station 202, when a particular icon, e.g. 304, is selected or made active by a user (such as by manipulating keyboard 232 or other auxiliary I/O device 228), the icon 304 or its immediate environment is modified such as by highlighting, shadowing or the like and the name appears in the name region.

In accordance with an embodiment of the invention, there is provided a user interface to a voice communication application (e.g. telephone, radio, etc.) provided by mobile station 202. As described previously, a voice communication application associated with an icon (e.g. icon 314) of application portion 301 may be activated by navigating a focus to the icon and selecting the icon such as by pressing an enter key of keyboard 232 or activating one of auxiliary I/O devices 228 such as a wheel or other pointing device. Persons skilled in the art will also recognize that a dedicated auxiliary I/O device 228, for example a reserved button or key of keyboard 232 may be used to directly initiate an application such as a voice communication application associated with icon 314. In accordance with a feature of the present invention, in the example embodiment, a voice communication application may also be activated from a main screen view such as in FIG. 3 by simply initiating an entry of a destination via keyboard 232.

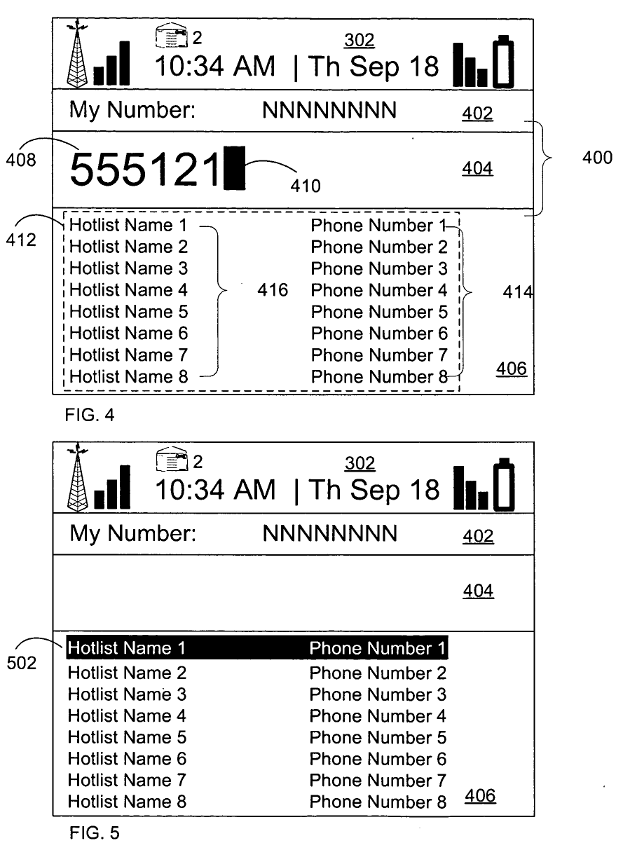

Referring to FIG. 4, there is illustrated an embodiment of a voice communication application screen 400 for a telephone application. Persons of skill in the art will appreciate that similar interfaces may be provided for other communications applications such as other voice applications or data applications such as e-mail, short message services (SMS), instant messaging (IM), web browsing using URLs, or the like. Voice communication application screen 400 overlays application portion 301 and comprises a mobile station telephone number portion 402, a telephone number dialog portion 404 and a hot list portion 406. Persons of ordinary skill in the art will appreciate that portion 402 is optionally displayed with portions 404 and 406 and that the particular arrangement of the portions on screen portion 301 is arbitrary.

Mobile station telephone number portion 402 displays a telephone number enabled by the station 202 via SIM 262. Hot list portion 406 provides a list 412 of telephone numbers 414 and associated names 416 which numbers 414 may be selected individually as described further below for convenient dialing. While a list showing both names and numbers may be advantageous, one or the other of names and numbers need not be shown. It will be understood by persons skilled in the art that a name may be selected by user and a destination such as telephone number associated with the name may be substituted by the wireless communications device to initiate the transmission of the appropriate communication.

FIG. 5 illustrates a selected individual entry 502 of list 412. List 412 may be compiled and ordered in accordance with various methods or rules. List 412 may be automatically generated, for example, from recently or frequently called names and/or numbers. An order of display of the entries in the list 412 may be determined in accordance with one or more methods/rules as well (e.g. alphabetic, most frequently called, most recently called, etc.). List 412 (or options therefor) may also be user configurable. For example, all or a portion of the list may include a list of specific numbers (e.g. favorite numbers or emergency numbers) regardless of frequency or time of last call occurrence.

Telephone number dialog portion 404 provides a prompt or field within which to compose a number to be called and comprises a telephone number 408 to be called as entered by keyboard 232 and a cursor 410 representing a focus within the dialog portion 404 for key-based entry. Persons of ordinary skill in the art will appreciate that cursor 410 may be manipulated to move about dialog portion 408 to facilitate the composition. For a telephone application; dialog portion 408 of the composition screen is preferably restricted to entry of those characters required for composing telephone numbers (e.g. numeric characters, certain punctuation) and may include characters representing pauses or tone interaction for automated telephone dialog dialing, for example, to facilitate automated information exchange for third party billing, voicemail, etc.

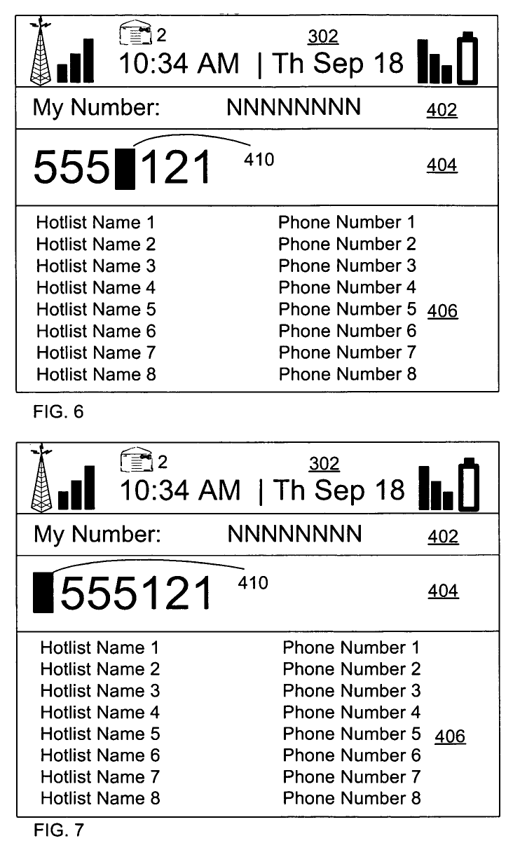

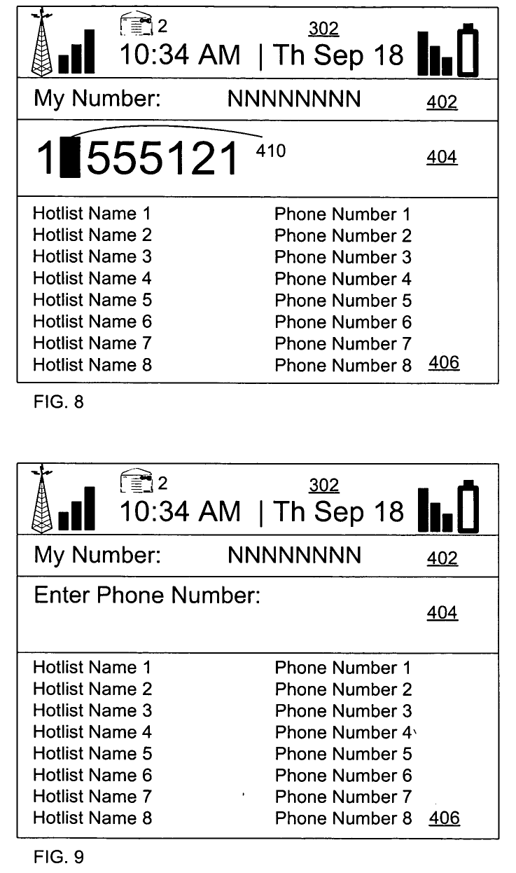

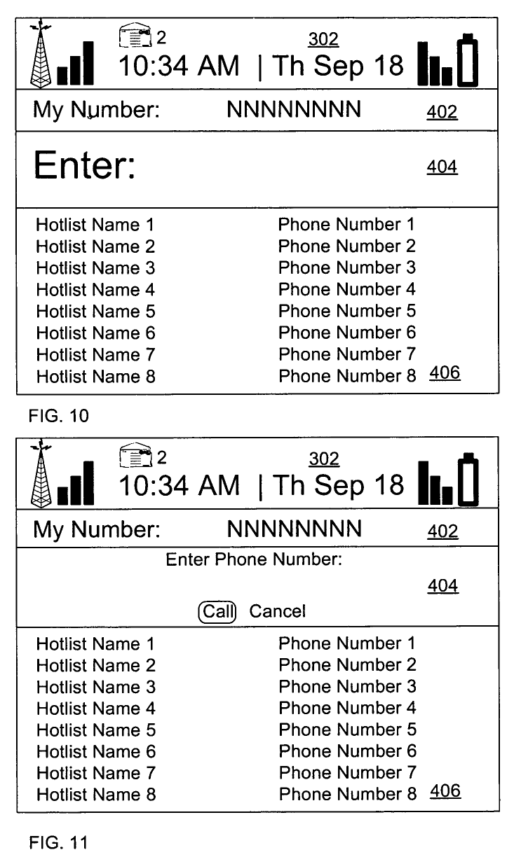

The present invention may be practiced in a variety of ways. Advantageously, for convenience, a font for the characters of the dialog may be selected to enhance readability. As shown, the font size may be relatively larger than surrounding information displayed on screen portion 301. Color and text effects may be selectable to facilitate reading. In an alternate embodiment, the phone number may be pasted, edited, and/or copied. For instance, the wheel or other pointing device may be rolled back or moved so as to easily traverse the entered digits or characters to a desired place within the characters to facilitate inserting, deleting, or changing a character or characters in the dialog. Alternatively, a combination of keys (e.g. an ALT character key and others) or a key in conjunction with a pointing device may be worked to insert or delete characters. FIGS. 6 through 8 illustrate an embodiment in which the pointing device or key pad is used to traverse the phone number, character by character or in its entirety, to the beginning and to insert the character “1” for a long distance telephone call. The cursor may be implemented so as to space between characters (e.g. FIG. 7) or be superimposed on a character (not shown). The cursor may be selected to be steady or blinking or may be fixedly set in a steady or blinking mode. The selection of mode may be established through a pull down menu that is displayed when a pointing device, such as a thumbwheel, is depressed. A prompt indicator field providing instruction may be added to the beginning of the dialog as illustrated, for example, in FIGS. 9 and 10. Background colors may be selectable to enhance the highlighting effect of the entered characters. In addition to the prompt field and the hot list, action buttons for terminating composition, such as call and cancel, may be added, as shown in FIG. 11. Activating the call button terminates composition and initiates communication to the destination while activating cancel terminates without initiating communication. In an embodiment related to FIG. 11, the prompt field may be highlighted by default and the call and cancel buttons may be disabled until either a phone number is input or selected from the hot list (or from a call log) (not shown). Entry of a single digit may enable the call and cancel buttons. In this embodiment, navigating to the hot list area may cause the hot list area to be highlighted (or, focused) while the prompt field loses focus.

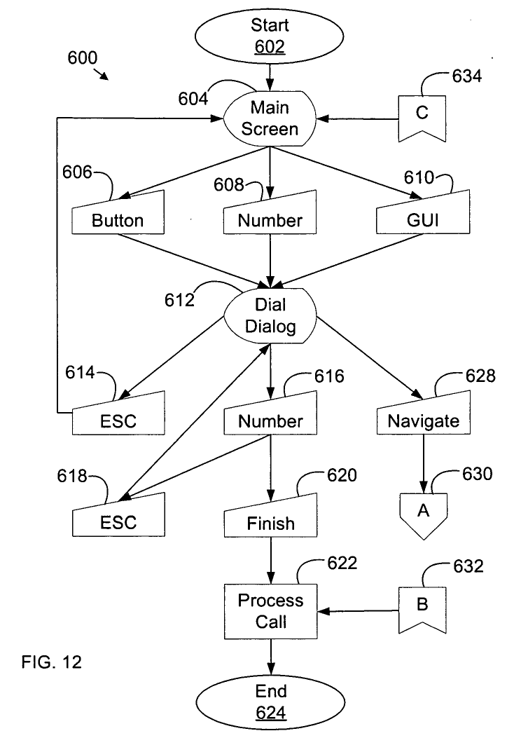

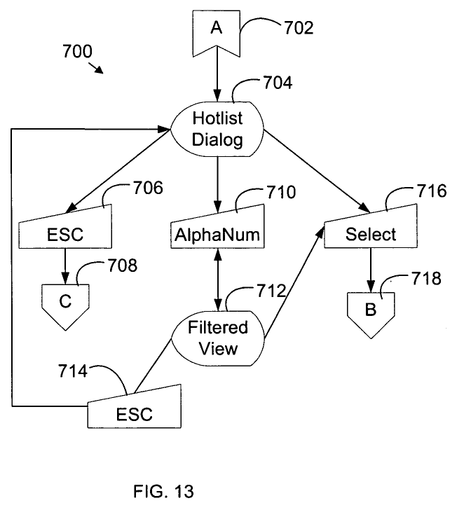

FIGS. 12 and 13 are a flowchart which describes a method for controlling the wireless communications device in accordance with an embodiment of the invention providing a user interface to a telephone application. FIG. 12 represents operations 600 for activating the telephone application and composing a destination (e.g. number to call) using one of the alternative composition means provided by the screen for composing, namely, a prompt. FIG. 13 represents detailed operations 700 for composing a destination using a second one of the alternative composition means, namely, the hot list portion 406.

Beginning at a start block 602 of FIG. 12, operations 600 commence and main screen 300 is displayed (step 604). To facilitate a more phone-centric interface for station 202, a plurality of methods to activate the telephone application is provided. As described earlier, a user may activate an auxiliary I/O device 228 such as a dedicated telephone button (step 606) to activate the telephone application and initiate telephone display screen 400 with a focus in dialog portion 401 (step 612). Alternatively, an icon (e.g. 314) or short-key (“P”) of application portion 301 may be manipulated (step 610) to invoke the telephone application at step 612. Advantageously to facilitate immediate dialing, keying a numeric or other key of keyboard 232 for composing a telephone number (step 608) will automatically activate the telephone dialing dialog at step 612, populating the dialog with the telephone number keyed (step 616).

While in the dialog portion 404 and before entering a number (step 612), a user may abort the application, such as by depressing an escape key of keyboard 232 or button of auxiliary I/O device 228 and return to main screen (step 604).

At step 616, a telephone number is entered. An abort at this stage (step 618) may return the user to a refreshed dialog portion 404 displaying no number to call. Once a telephone number to call is composed in dialog portion 404, the final entry may be indicated (step 620) such as by pressing an enter key of keyboard 232 or a click of a wheel or other pointing device of auxiliary I/O device 228 and the entered telephone number is processed (step 622) by the telephone application thus ending a call composition and initiation phase of the application (end 624). Details of any remaining phases (e.g. transmitting the communication) are not shown but are understood to persons of ordinary skill in the art.

In addition to direct telephone number entry facilitated through dialog portion 404 and steps 616-624, following step 612, calls may be initiated via hot list portion 406. A user may navigate from dialog portion 404 to hot list portion 406 (step 628) using a navigation means of station 202 such as previously described. Further steps for hot list portion 404 are illustrated in FIG. 13 where outgoing flowchart reference A 630 mates to companion incoming reference A 702.

Following navigation to the hot list (step 628) the focus switches from dialog portion 404 to hot list portion 406 as illustrated in FIG. 5. An entry 502 in the list 412 may be highlighted to indicate the focus. A user may abort hot list entry (step 706) and return to the dialog portion (not shown) or, as illustrated via outgoing reference C 708 and incoming reference C 634 (FIG. 12), to main screen (step 604). In the hot list, a user may enter alphanumeric characters (step 710) to initiate a filtered view (step 712) of an address book (not shown) provided by multi-tasking mobile station 202. As known to persons skilled in the art, the alphanumeric characters defining a contact filter may be used to filter a name or other field(s) from the address book or other list of contacts to display a list of address book entries from which to select an entry for calling (step 716). The filtered view may be aborted (step 714) to return to hot list dialog, for example as shown in FIG. 5, (step 704).

At step 716, an entry from the hot list portion 406 or a filtered address book list (not shown) is selected for calling using a selecting means as previously described. The call is processed (step 622) as indicated by companion references B 718-632.

Operations 600 and 700 show an embodiment of a user interface to permit a user to start typing a telephone number immediately from a home screen or the telephone application as well as conveniently select a number from a hot list in an integrated fashion. Activation of the telephone application initiates an immediate dialing dialog and a hot list display to facilitate convenient dialing from a memory of the device. Entry from the main screen may populate the immediate dialing dialog with the keyed destination to speed calling operations.

Though the invention has been described with reference to a telephone and voice communications, persons of skill in the art will appreciate that a similar though modified interface may be provided for other voice applications (e.g. radio communications) or data applications (e.g. e-mail) for composing a number, address or other destination to which a communication is to be initiated by the wireless communications device 102. The device may be configurable to provide such a user interface for more than one application to allow the user to enable a more phone centric device or e-mail centric device.

Advantageously, a user is presented with a destination composition screen presenting alternative means with which to compose a destination. The prompt facilitates a spontaneous or more direct entry, using a key-based input device such as a keyboard, of a destination known to the user. The list facilitates composition of the destination from candidate destinations “known” by (i.e. stored to) the wireless communications device. By way of further advantage, the screen for composing a destination may be automatically invoked from a home screen for controlling the wireless device by simply commencing to key in the destination. The activation of the outgoing transmission feature is thus prioritized over other features and the interface makes the device easier to operate, reducing key presses, than one requiring the activation of specific input devices (e.g. short-cut keys) or a typical interaction with the graphical interface of the home screen.

In one embodiment, where the communication comprises a data message, the method includes a step of composing the data message before the step of transmitting. The invention may be applied to voice communications or data communications and the method may accommodate the composition of a data message.

The list of candidate destinations may be defined with reference to recent destinations to which communications are transmitted. A rule for defining the list may be used and the rule may be configured by a user to prioritize destinations in the list. For example, the rule could prioritize most frequently used destinations or most recently used destinations. Specific destinations may be made candidates regardless of frequent or recent use. Although a hot list could be implemented as a call log, one of ordinary skill will recognize that the hot list may be a customized list of calls through manual entry and maintenance and/or through the use of intelligence built within the device to prioritize candidate phone numbers.

In a further embodiment, the memory may store a list of contacts each having a destination associated therewith and the step of composing the destination may comprise activating the key-based input device to input a contact filter. A filtered list of destinations from the list of contacts is provided in response to the contact filter and the filtered list is selectable to choose the destination. A one of the input devices maybe activated to select the destination from the filtered list. In addition to the two previously described alternative composition means of prompt and hot list, this embodiment provides a third means to compose a destination. The destination may be selected from a contact list stored to the wireless communications device. The presentation of the contact list is triggered by inputting a contact filter using the key-based input device.

In accordance with any of the methods, the destination may be one of a telephone number, an email address, an instant message (IM) address, a URL address and a name of a recipient to which the communication is to be transmitted. As the method is useful for voice or data communications, it is useful to compose a respective destination according to the type of communication to be sent. Thus a wireless communication device may be configured to treat a key-based input at a home screen as the input of a telephone number to initiate the composition screen for a telephone call. Alternatively, a wireless communication device may treat the input as an email address to initiate an email address composition screen. Thereafter an email message composition screen may be invoked. Similarly, the wireless device could be configured to prioritize web browsing with URL address destinations, text messages with SMS addresses (e.g. telephone numbers), instant messages, etc.

The above-described embodiments of the present application are intended to be examples only. Those of skill in the art may effect alterations, modifications and variations to the particular embodiments without departing from the scope of the application. The invention described herein in the recited claims intends to cover and embrace all suitable changes in technology.

1. A wireless communications device for use in a wireless network comprising:
a user interface for controlling the operations of the wireless communications device including a component to compose a destination for an outgoing communication generated by the device, said component providing together:
a prompt for receiving the destination from a user; and
a hot list of candidate destinations from which the user may select the destination.

2. The wireless communications device of claim 1 including:
a key-based input device to input the destination.

3. The wireless communications device of claim 2 wherein the user interface comprises a home screen component from which to invoke a feature from among a plurality of features provided by the device; and wherein the component to compose a destination is invokable from the home screen component automatically in response to an input from the key-based input device of a portion of the destination.

4. The wireless communications device of claim 3 wherein the destination is a telephone number to be called and the input is a portion of a telephone number.

5. The wireless communications device of claim 3 wherein the portion of the destination populates the prompt when the component to compose a destination is invoked.

6. The wireless communications device of claim 1 wherein the component to compose a destination is invokable in response to at least one of: an interaction with a home screen component of the user interface from which to invoke a feature from among a plurality of features provided by the wireless communications device; and an auxiliary input device.

7. The wireless communications device of claim 3 wherein the component to compose a destination is further invokable in response to at least one of: an interaction with the home screen component of the user interface; and an auxiliary input device.

8. The wireless communications device of claim 1 wherein the component to compose a destination is navigable by a user to move between the prompt and hot list.

9. The wireless communications device of claim 1 wherein the component to compose a destination is adapted to provide a filtered list of destinations from a store of destinations on the device in response to a filter input by the user, said filtered list selectable by the user to choose a destination.

10. The wireless communications device of claim 1 wherein the prompt is adapted to permit a user to navigate and change the destination while composing.

11. The wireless communications device of claim 1 wherein the component to compose a destination is adapted to provide at least one action button for terminating composition of the destination.

12. In a wireless communications device for use in a wireless network, a method for composing a destination for an outgoing communication generated by the device comprising providing a composition screen including, together:
a prompt for receiving the destination from an input of a user; and
a hot list for selecting the destination by the user, the hot list comprising candidate destinations from which to select the destination.

13. The method of claim 12 including:
receiving the destination using the prompt in response to a key-based input from the user.

14. The method of claim 13 comprising:
providing a home screen from which to invoke a feature from among a plurality of features provided by the wireless communications device; and
invoking the providing of the composition screen from the home screen automatically in response to the input of a portion of the destination.

15. The method of claim 14 wherein the destination is a telephone number to be called.

16. The method of claim 14 comprising populating the prompt with the portion of the destination.

17. The method of claim 12 comprising:
providing a home screen from which to invoke a feature from among a plurality of features provided by the device; and
invoking the providing of the composition screen from the home screen in response to one of: an input of a portion of the destination; an interaction with the home screen; and an activation of an auxiliary input device dedicated to invoke the composition screen.

18. The method of claim 12 comprising moving between the prompt and hot list in response to navigation about the composition screen by the user.

19. The method of claim 18 comprising receiving the destination selected from the hotlist and generating the outgoing communication in response.

20. The method of claim 13 comprising providing a filtered list of destinations from a store of destinations on the wireless communications device in response to a filter input by the user, said filtered list selectable by the user to choose the destination.

21. The method of claim 12 comprising receiving the destination and generating the outgoing communication in response.

22. The method of claim 12 comprising providing a cursor adapted to permit a user to navigate and change the destination while composing.

23. The method of claim 12 comprising providing at least one action button for terminating composition of the destination.

24. A computer program product having a computer readable medium tangibly embodying computer executable code for composing a destination for an outgoing communication generated by a wireless communications device for use in a wireless network, said computer program product comprising:
code for a composition screen providing, together:
a prompt for receiving the destination from an input of a user; and
a hot list for selecting the destination by the user, the hot list comprising candidate destinations from which to select the destination.
